(19) United States
(12) Patent Application Publication
(10) Pub. No.: US 2006/0206398 A1
(43) Pub. Date: Sep. 14, 2006

(54) Managing risks within variable annuity contractors

(76) Inventor: John L. Coughlin, Boston, MA (US)

Correspondence Address: GOODWIN PROCTER LLP;PATENT ADMINISTRATOR, EXCHANGE PLACE, BOSTON, MA, 02109-2881, US

(21) Appl. No.: 11/331,821

(22) Filed: Jan. 13, 2006

Related U.S. Application Data
(60) Provisional application No. 60/643,465, filed on Jan. 13, 2005.

(51) Int. Cl. G06Q 40/00

(52) U.S. Cl. 705/35

(57) ABSTRACT

A method for mitigating risks associated with a reinsured annuity contract includes reinsuring variable annuity contracts having guaranteed minimum death benefits, calculating risk statistics based on one or more characteristics of the plurality of guaranteed minimum death benefit variable annuity contracts, determining a set of market indices that model the performance of the reinsured variable annuity contracts based on the plurality of risk statistics, and hedging the risks associated with the reinsured variable annuity contracts by purchasing one or more option contracts based on the determined market indices.

### CROSS-REFERENCE TO RELATED APPLICATIONS

This application claims priority to and incorporates by reference in its entirety U.S. provisional patent application Ser. No. 60/643,465, filed Jan. 13, 2005.

### FIELD OF THE INVENTION

The invention relates generally to mitigating financial risks. More specifically, the invention relates to analyzing aspects of variable annuity contracts and hedging the financial exposure created by offering these contracts using changes in the equity and fixed income markets.

### BACKGROUND

Variable annuity contracts are purchased by individuals (the “contract owners”) as a form of insurance that also serves as an investment vehicle during the accumulation phase of the contract. Premiums paid by the contract owner are used to buy units in separate investment accounts of the insurance company that wrote the insurance contract. The account value of the variable annuity contract is based on the value of the underlying units in these separate accounts. One benefit of these insurance products is that the gains realized during the term of the contracts can be accrued tax-free, even as funds are transferred among the accounts.

Variable annuity contracts often also contain guarantees of financial payment to a beneficiary upon the death of the owner. For example, some contracts guarantee that the amount payable upon death (the “death benefit”) of the contract will never be less than the total premiums paid during the life of the contract. Other contracts guarantee that the death benefit will be equal or greater than the amount of an initial premium plus interest based on a predetermined annual rate. Some guarantee that the death benefit will be at least the value of the account at a predetermined time if that amount is greater than a previously guaranteed amount (called a “ratchet-up”), as well as other guarantees that the payout will be in excess of the premium.

Variable annuity contracts can also include guarantees that the account value will be at least equal to a pre-determined minimum amount at a pre-determined point in time, that the amount of annuity income available from the contract will be at least a minimum amount, and/or that the amount of withdrawal benefits which can be taken from a contract will at least equal the contract premium.

Historically, many insurance companies have purchased reinsurance in an attempt to share the risk that there will be inadequate funds available to cover these guarantees. Typically reinsurance companies spread risks by pooling the risks of multiple companies and contracts. Specifically, insurance companies pay a premium to cede a portion of their risk so that if losses are above a negotiated amount, the reinsurance company will reimburse the insurance company for these excess losses. Since the reinsurance company assumes risks from multiple companies, any losses incurred from business assumed from one insurance company are expected to be outweighed by profits from another company, thus allowing the reinsurance company to make a profit. Over the years, most reinsurers have withdrawn from providing coverage for variable annuity contracts having features such as those described above because of the high correlation among the contracts, and thus the risk could not be mitigated by pooling risks from multiple companies. Because of the inability of insurance companies to reinsure variable annuity contracts, they incurred large economic losses during the stock market decline from 2000 to 2002.

### SUMMARY OF THE INVENTION

The present invention related to systems and techniques whereby the risks associated with reinsured variable annuity contracts can be hedged through the systematic purchase and sale of futures and options from investment indices. Indications derived from the variable annuity contracts determine the amount and duration of futures and options that can be purchased to hedge the annuity guarantees on an economic basis.

In one aspect of the present invention, a method for mitigating risks associated with a reinsured annuity contract includes measuring risks associated with the contract and mitigating the measured risks through active hedging. The annuity contract may include one or more minimum benefits, such as minimum income, minimum accumulation, and minimum withdrawal. In some embodiments, the annuity contract is purchased from a guarantor of the contract, and may also include an income stream as well as a payout risk.

Measuring the risk may include calculating an account value for the contract, and in some instances may involve one or more account features of the contract, and/or demographics of the policyholder of the contract (e.g., age, gender, and mortality rate). Examples of account features include a product type, a death benefit, a withdrawal amount, a lapse period, a ratchet value, a fund selection, and a rollup value.

In another aspect, a method of hedging risks associated with reinsuring variable annuity contracts that include guaranteed minimum death benefits includes reinsuring variable annuity contracts with guaranteed minimum death benefits, calculating risk statistics based on characteristics of the variable annuity contracts, determining a set of market indices (e.g., the Standard & Poor's 500 index, the Russell 3000 index, the Wilshire 5000 index, the NASDAQ 100 index, the Dow Jones index, and the Europe, Australia and Far East (EAFE) index) to model the performance of the reinsured variable annuity contracts based on the risk statistics, and hedging the risks associated with the reinsured variable annuity contracts by purchasing option contracts (such as put options) based on the determined market indices.

In some embodiments, the guaranteed minimum death benefits include both an income stream (which can be used to calculate a first risk statistic) and an on-death payout amount (which can be used to calculate a second risk statistic).

In yet another, a system for identifying hedge positions to mitigate risks associated with reinsuring guaranteed minimum death benefit variable annuity contracts includes a data storage module for storing information associated with guaranteed variable annuity contracts having been purchased from a primary insurer, a processing module for calculating risk statistics (either periodically, or on a one-time basis) based on the information associated with the guaranteed variable annuity contracts, and a hedging engine for identifying hedge positions to mitigate risks associated with the guaranteed variable annuity contracts based on the calculated risk statistics.

In one embodiment, the system further includes a trading system for executing trades associated with the hedge positions. The system can also include a reporting module for producing reports, which may be formatted for printing. In some embodiments, the system also includes a communications module that is configured to receive information associated with the variable annuity contracts.

### BRIEF DESCRIPTION OF THE DRAWINGS

FIG. 1 is a block diagram showing the environment in which the invention operates.

FIG. 2 is a block diagram detailing the steps of the invention as it operates in the environment of FIG. 1.

FIG. 3 is another block diagram detailing steps of the invention as it operates in the environment of FIG. 1.

FIG. 4 is a diagram of one implementation of the invention, which can be realized with one or more appropriately programmed general-purpose computers.

### DETAILED DESCRIPTION

In general, reinsurance operates as a contract between two parties, an insurance company (the “issuer”) and a reinsurance company (the “reinsurer”). The reinsurance contract specifies the consideration, risks transferred, terms, and financial details of the relationship between the two parties. Different types of insurance contracts contain different types of risks, depending on the terms of the contract. One example of a risk inherent to variable annuity contracts involves the risk that the amount the issuer must pay to the beneficiary of the contract upon the death of the annuitant is greater than an accumulated account value of the policy. Another risk associated with variable annuity contracts is that the guaranteed amount available upon surrender or systematic, periodic withdrawal exceeds the account value when the withdrawals are requested or due. Each of these risks can be “transferred” by purchasing insurance—i.e. insuring the insurance, from a reinsurer. Generally, the terms of the reinsurance contract would then specify the amount that the reinsurer pays the issuer to compensate for a loss due to the risks mentioned above.

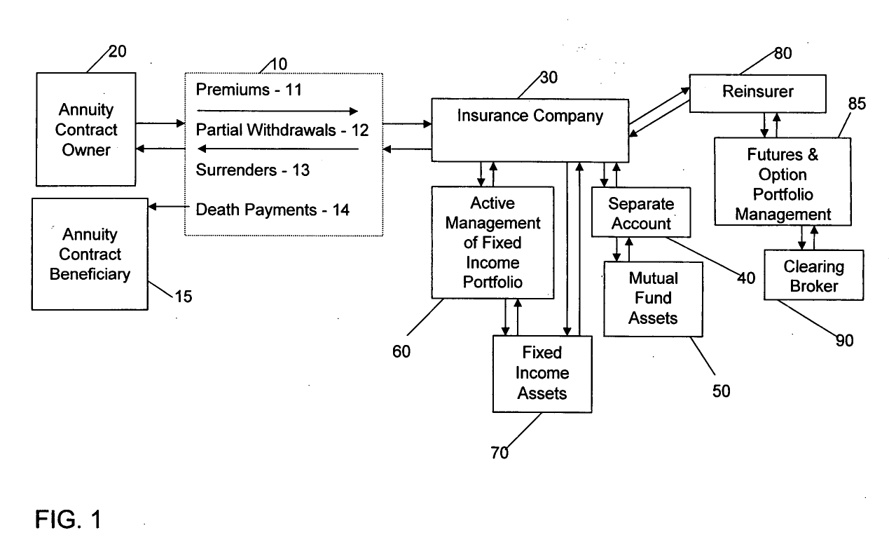

FIG. 1 illustrates the market environment of a variable annuity contract 10 according to one embodiment of the present invention. An annuity contract owner 20 pays premiums 11 to an insurance company 30. The annuity contract owner 20 can request partial withdrawals from the contract 12 or surrender 13 the contract for its cash surrender value. Upon death of the contract owner 20, a death benefit 14, as described below, is paid to the beneficiary 15 of the contract, generally designated by the contract owner 20.

Premiums 11 paid on a variable annuity contract 10 are subsequently used to buy units of separate accounts 40 of the insurance company 30. The separate accounts 40 contain shares of segregated asset accounts (usually mutual funds) 50 established by the insurance company 30 which are established according to the United States Federal Internal Revenue Service's Regulations for investment funds for variable annuities. By design, the annuity contract owner 20 earns a proportionate share of income and gains and losses in the separate accounts 40 by the change in unit values of the mutual funds 50. The insurance company 30 may also manage a fixed income portfolio 60 and invest in fixed income assets 70 for the amount of account value that the contract owner 20 desires to be invested in the fixed account. The insurance company 30 then earns a return on these assets, and passes a portion back to the contract owner 20 through credits to the account value.

The information on the in-force records is sent to a reinsurer 80 who then aggregates the information for many direct writers of variable annuities. To financially offset the net risks inherent in the variable annuity, future and options positions are bought, sold, and traded according to mathematical formulae and statistical analysis.

In some instances, the minimum guaranteed death benefits offered in the variable annuity contact 10 will exceed the cash surrender value of the contract 10. This may be due to large fluctuations in the stock market that affect the values of the underlying mutual fund assets 50, the payment of a surrender charge, or the death of the contract owner 20 that is statistically unforeseen based on mortality rates and actuarial tables, although the surrender charge is typically not collected on the death of the contract owner 20. Other features of variable annuities include those listed below.

Return of Premium: The return of premium feature requires the payment of the greater of the account value or total premiums paid on the contract less any partial withdrawals and assessments. For example, assume the premium paid for an annuity contract with a return of premium guarantee is $100,000. At the time of the death of the account owner, however, the account value is only $50,000 because of a sharp decline in the stock market. In this case, the beneficiary of the contract would receive $100,000 and the issuing insurance company would incur a $50,000 loss ($100,000 paid at death less the $50,000 account value released to the beneficiary).

Reset: The reset feature provides the greater of a return of premium or the most recent specified anniversary account value, adjusted for withdrawals, upon death. There is typically a maximum age above which the benefit will not increase. For example, assume the premium paid for an annuity contract with an annual reset guarantee is $100,000. At the end of the first year, the account value has grown to $150,000. The reset amount is $150,000, which is the greater of the $100,000 premium paid and the $150,000 account value. Now assume the annuitant dies in the second year. At the time of death, the account value is only $50,000, In this case, the beneficiary would receive $150,000 and the insurance company would incur a $100,000 loss ($150,000 paid at death less $50,000 account value released). Now instead of death, assume the annuitant lives until the third year. Also assume that the account value at the end of the second year is $75,000. The annual reset value is now $100,000, which is the greater of the $100,000 premium paid and the $75,000 account value. Now assume the annuitant dies in the third year. At the time of death, the account value is only $85,000, In this case, the beneficiary would receive $100,000 and the insurance company would incur a $15,000 loss ($100,000 paid at death less $85,000 account value released).

Ratchet: The ratchet feature guarantees the payout on the contract to be the greater of a return of premium death benefit or the highest specified “anniversary” account value (prior to a maximum age), adjusted for withdrawals, upon death. The specified anniversary might be the monthly anniversary of contract issuance, the annual anniversary, the birthday of the contract owner, or some other specified anniversary. Assuming, as above, a $100,000 contract, with a value at the end of the first anniversary period of $150,000 and a value at the end of the second anniversary period of $85,000. If payout occurs after the first year, the ratchet value is $150,000, which is the greater of the $100,000 premium paid and the $150,000 account value at the end of year one. However, the results change after year two because the ratchet value is the greatest of the $100,000 premium paid, the $150,000 account value at the end of the first contract year, and the $85,000 account value at the end of the second contract year. In this case, the beneficiary would receive $150,000 and the insurance company would incur a $65,000 loss ($150,000 paid at death less $85,000 account value released).

Rollup: The rollup feature guarantees a payment that is the greater of a return of premium death benefit or premiums, adjusted for withdrawals, accumulated at a specified interest rate, either simple or compound, up to a maximum age or maximum percentage or premiums less withdrawals upon death. For example, assume the guarantee is a 5% simple interest rollup. Further assume the premium paid for an annuity contract with this guarantee is $100,000. At the end of the first year, the rollup guarantee is $105,000 ($100,000 premium paid plus 5% interest.) If death occurs in the second year, the beneficiary would receive the greater of the account value and the rollup benefit of $105,000.

Earnings Enhancement: This feature provides an enhancement to the death benefit that is a specified percentage of the adjusted earnings accumulated on the contract at the date of death. The benefit may be capped as to amount or value at a given age. For example, assume the guarantee is a 20% earnings enhancement. Further assume the premium paid for an annuity contract with this guarantee is $100,000. At death the account value is $200,000. The earnings enhancement would be $20,000, which is 20% of the earnings on the contract ($200,000 account value less $100,000 premium paid) and the amount paid at death would be $220,000.

A variable annuity contract may have one or more of these features. The death payment is typically the greater of the account value or the death benefit as described above.

The death benefit 14 paid in excess of the account value creates an amount that is paid out by the insurance company 20 to the beneficiary upon the death of the annuitant. Because these payouts can be determined in advance, they are similar to put options that are actively traded in the equity markets.

Put options give buyers the right, but not the obligation, to sell an underlying security at a particular price (the “strike price”) at a particular time. A put option is considered “in-the-money” (ITM) if its strike price is above the current trading price of the underlying security. A put option is “out-of-the-money” (OTM) if its strike price is below the current price of the underlying security. A put option is “at-the-money” (ATM) if its strike price is the same as (or close to) the current price of the underlying security. The security, or “underlier” may be a stock, a combination of stocks, derivatives of stocks, or a stock index.

Strike price, also called exercise price, is the specified price on an option contract at which the contract may be exercised, whereby a put option buyer can sell the underling security. The buyer's profit from exercising the option is the amount by which the strike price exceeds the spot price. In general, the smaller the difference between spot and strike price, the higher the option premium.

Spot price, also called cash price, is the present delivery price of a given security being traded on the spot market. An American option is an option that can be exercised anytime during its life. The majority of exchange-traded options are American style options—i.e. an owner of an option can trade it on the open market at any time. A European option is an option that can only be exercised at the maturity date. An Asian option, also known as an average option, is an option whose payoff depends on the average price of the underlying asset over a certain period of time as opposed to only at maturity. However, unlike an American Option, which can be executed at any time, a European Option, which can only be executed at expiry, or an Asian Option, which can only be executed at predetermined times, the “put” feature of the variable annuity can only be exercised upon death. Therefore, the amounts by which a variable annuity contract is “in the money” (the amount that the payable death benefit exceeds the account value based on the underlying investments) is unknown in advance.

Consequently there is no direct offsetting option position available within the financial markets that accurately mirrors the risks inherent in a variable annuity contract with a benefit paid at death. A further complication to the calculation of an offsetting option position is the fact that the investments of the separate accounts of the variable annuities usually do not directly correspond to established indices on which options are usually traded.

The guaranteed minimum income benefit, the guaranteed minimum accumulation benefit and the guaranteed minimum withdrawal benefit are all put type options after the passage of time and provide a floor on the cash payments available to the annuity owner. Like guaranteed minimum death benefits, these contracts can result in a loss to the insurance company upon exercise of the option, but the triggers are different, namely withdrawal versus death. However, aggregating the contracts (e.g., as a reinsurer) such that a series of risk statistics can be computed provides an opportunity to match these statistics with similar statistics for various market indices. Once a market index can be linked to a collection of contracts, options are then purchased based on that index as a hedge against the risks inherent to the contracts. The benefits of using such an approach increase as the number of number of contracts increases due to the law of large numbers. Therefore, the approach is well suited for the reinsurance model because the reinsurance company can pool the mortality risk among a large number of companies, thereby lessening the financial risks due to the few deaths of contract holders that are well outside of statistical and actuarial norms.

More specifically, the invention uses actuarial mathematics uniquely combined with financial modeling to calculate hedging positions for offsetting these risks. Financial modeling determines the present value of the liability portfolio based on the guaranteed minimum death benefits (GMDBs). The liability portfolio is valued first using market inputs for stock and stock index levels, interest rate levels at numerous maturities and implied or assumed volatility levels at different maturities, in addition to the actuarial assumptions. The stock prices, index levels, interest rates and volatility assumptions are referred to collectively as parameters. The liability portfolio is then revalued for alternative sets of parameters. The change in value of the liability portfolio is computed for each of these sets. Portfolios of equity, equity index futures, interest rate swaps and options on all the above are determined that have the opposite change in valuation for every alternative parameter assumption set. There are a large number of such portfolios that can be generated that satisfy this criterion; the desired portfolio is the one of these portfolios that optimizes a predetermined criterion, e.g. the one that minimizes expected transaction costs over time. The desired positions are then sent to futures and options traders 85 who execute the transactions on behalf of the reinsurer 80, and are held at a clearing broker/dealer 90.

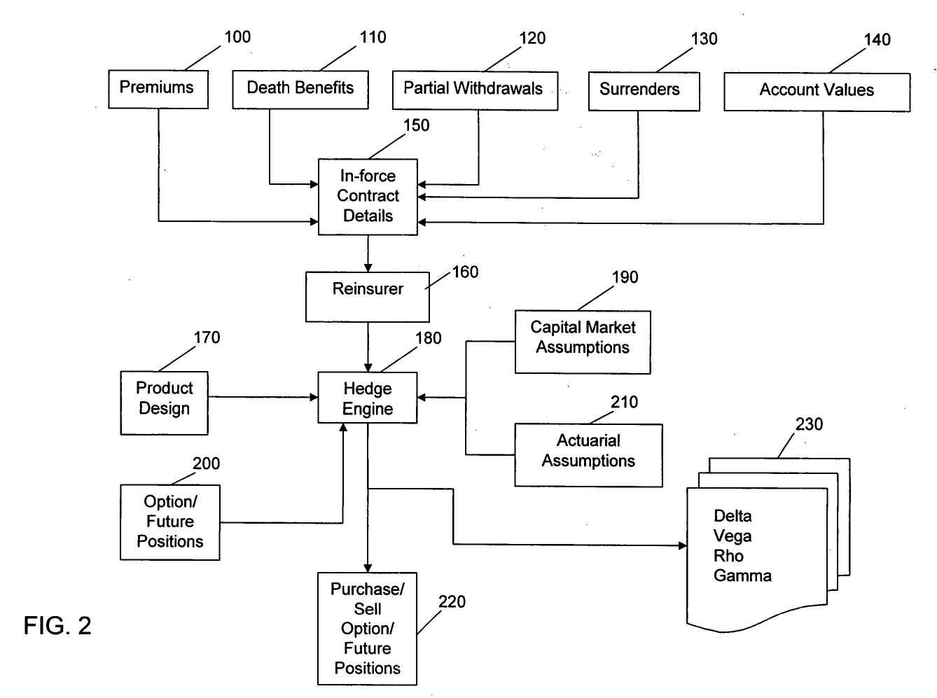

FIG. 2 is a flow diagram describing a method for an insurance company to reduce the risk of providing the guarantees on the death payments. The premium payments 100, death benefits in-force 110, partial withdrawals 120, surrenders 130 and account values 140 are summarized into in-force contract details 150. The data is forwarded to the reinsurer 160, and analyzed. One aspect of the analysis summarizes the in-force data of all the contracts. The summary compresses on cell data but will allow for values to be calculated similar to those that would be obtained with complete details. The summarization process looks for errors and other out of bounds conditions in the policy detail and places the data into appropriate groups for modeling. The output from the in-force contract detail system is fed into the hedge engine 180. The hedge engine 180 projects forward the financial results obtained for the company using scenarios based upon the types of investments in the variable accounts and capital market assumptions.

The various product characteristics 170 of the variable annuity are also input into the hedge engine 180. Examples of product characteristics include death benefit guarantees, guaranteed minimum income, accumulation benefit or withdrawal benefits, separate account and fixed account availability and performance, provisions regarding surrenders and partial withdrawals and their impact on guarantees as well as transfer between separate accounts. In many cases, this information can be found in the prospectuses for the variable annuities and various separate accounts, and transferred electronically or manually into the hedge engine 180. Capital market assumptions 190 are also input into the hedge engine 180. These assumptions include risk free rates, volatilities, correlations of funds, skew and kurtosis, as well as other statistical measurements and data describing the conditions of the capital markets. Risk neutral and real world assumptions are also used as input items.

The risk free rate is the quoted rate on an asset that has virtually no risk. As an example, the interest rate quoted for US treasury bills are widely used as a risk free rate. Volatility is a statistical measure of the tendency of a market or security to rise or fall sharply within a period of time. Volatility is typically calculated by using variance or annualized standard deviation of the price or return. A measure of the relative volatility of a stock as compared to the overall market is its beta. A highly volatile market means that prices have large swings in very short periods of time. Fund correlation describes a complementary or parallel relationship between two funds. For example, two funds that invest within the same industry will show similar returns, and therefore have a high fund correlation. Skew is a statistic describing a situation's asymmetry in relation to a normal distribution. A positive skew describes a distribution favoring the right tail of the normal distribution, whereas a negative skew describes a distribution favoring the left tail of the normal distribution.

Kurtosis is a statistical measure used to describe the distribution of observed data around the mean. Used generally in the statistical field, it describes trends in charts. A high kurtosis portrays a chart with fat tails and a low even distribution, whereas a low kurtosis portrays a chart with skinny tails and a distribution concentrated towards the mean. It is sometimes referred to as the “volatility of volatility.”

The characteristics of the current options and futures positions 200 are also used as input into the hedge engine 180. These are typically analyzed in terms of the statistical terms 230 such as delta, gamma, vega, theta and rho that are also calculated by the hedge engine 180. These terms have the following meanings in their statistical investment analysis context.

Delta is the amount by which an option's price will change for a one-point change in price by the underlying entity. Call options have positive deltas, while put options have negative deltas. Technically, the delta is an instantaneous measure of the option's price change, so that the delta will be altered for even fractional changes by the underlying entity.

Gamma is the rate of change in an option's delta for a one-unit change in the price of the underlying security.

Theta is a measure of the rate of change in an option's theoretical value for a one-unit change in time to the option's expiration date.

Vega is a measure of the rate of change in an option's theoretical value for a one-unit change in the volatility assumption.

Rho is the expected change in an option's theoretical value for a one percent change in interest rates.

Methodologies such as Black-Scholes can be used when all but one of the parameters are known to derive the unknown parameter, as well as other methods, including a generic description of Black-Scholes, like “option pricing models.” Black-Scholes is a theoretical option-pricing model widely used in the market that provides an option cost based upon the index price, exercise price, option term and assumptions of risk free rates of return, average dividend yield, and volatility (standard deviation) of returns.

Actuarial assumptions 210 are used to provide mortality rates, surrender rates, partial withdrawal rates, fund mapping and expenses. Mortality rate is the probability that the annuitant will die within the following year. Surrender rate is the probability that the annuity contract will surrender within the following year. Partial withdrawal rates are the probability and amount of less than full surrenders within the following year. Fund mapping is the process of analyzing separate account funds and assigning them to indices that can be hedged.

Expenses refers to both the marginal cost to the reinsurance company as a result of entering into a reinsurance agreement as well as to general overhead of the reinsurance company that has been allocated to this reinsurance contract.

Experience studies may be utilized to provide the information as well as industry experience and professional judgment. The projection of in-force data is used to verify experience factors using actuarial validation techniques. Returns on the separate account investments are correlated to investment indexes by use of fund mapping. For example, a fund that primarily invests in large US corporations would be mapped to the S&P 500. Funds with other objectives, such as small companies with small capitalization, foreign or developing countries, or other objectives, would be mapped to other indices. Although there is not necessarily be a one to one correlation between the fund performance and index performance, the index serves as a reasonable predictor. A reinsurance company has an advantage that it can pool separate accounts of several companies to achieve better correlations. There may be some separate accounts that do not correlate well with any index, and as such, hedging does not work.

Definitions of common fund indices are as follows:

S&P: The Standard & Poor's 500 is an index of the 500 largest publicly traded US corporations. Most of the companies that are included in the index have their shares traded on the New York Stock Exchange (NYSE). The S&P 500 is an index which is the most widely used benchmark for large capitalization stock investments. Considered to be a benchmark of the overall US stock market. This index is comprised of 500 widely-held, Blue Chip stocks representing industrial, transportation, utility and financial companies with a heavy emphasis in industrials.

The Russell 3000, supplied by The Frank Russell Company, is a stock index consisting of the 3000 largest publicly listed US companies, representing about 98% of the total capitalization of the entire US stock market. Different subsets of the Russell 3000 are the Russell 1000 (large caps), which consists of the 1000 largest companies in the Russell 3000, the Russell 800 (mid caps), which consists of the smallest 800 companies in the Russell 1000, and the Russell 2000 (small caps), which consists of the smallest 2000 companies in the Russell 3000.

The Wilshire 5000 Total Market Index measures the performance of all US headquartered equity securities with readily available price data. This index is a capitalization-weighted index and includes all of the stocks contained in the S&P 500 Composite Stock Price Index. This index is intended to measure the entire U.S. stock market. A stock index that provides a broad measure of trends in stock prices across the whole of the market, the Wilshire 5000 consists of approximately 6,500 US-based stocks traded on the New York Stock Exchange, American Stock Exchange and NASDAQ.

The NASDAQ-100 Index is a “modified capitalization-weighted” index designed to track the performance of a market consisting of the 100 largest and most actively traded non-financial domestic and international securities listed on The NASDAQ Stock Market, based on market capitalization. To be included in this index, a stock must have a minimum average daily trading volume of 100,000 shares. Generally, companies on this index also must have traded on NASDAQ, or been listed on another major exchange, for at least two years. NASDAQ (National Association of Securities Dealers Automated Quotation System) is the electronic stock exchange run by the National Association of Securities Dealers for over-the-counter trading. Established in 1971, it is America's fastest growing stock market and a leader in trading foreign securities and technology shares as well. It boasts many more listed companies than the New York Stock Exchange, and handles more than half the stock trading that occurs in this country. Although once the province of smaller companies, NASDAQ today is where many leading companies are traded, including Microsoft, Intel, MCI, Amgen, Cisco Systems, Nordstrom, Oracle, McCormick, SAFECO Insurance, Sun Microsystems, T. Rowe Price, Tyson Foods and Northwest Airlines.

EAFE, the Europe, Australia, and Far East Index from Morgan Stanley Capital International is an unmanaged, market-value weighted index designed to measure the overall condition of overseas markets.

Periodically, the invention embodied in the hedge engine 180 calculates the delta, gamma, vega, theta and rho of the book of variable annuity business. Multiple economic environment scenarios are generated and the results for the In-Force Contract Details 150 are projected forward under these economic scenarios. This can be a computation-intensive process and often runs on multiple computers in a grid, server farm, or other multi-processor environment. The risk of reduction in the income stream, as measured by a charge based upon the change in guaranteed minimum death benefit of an increase in the payout stream as represented by the death payments is measured by the hedge engine 180.

Characteristics such as term of the underlying options are established and the hedge engine 180 calculates the amount of available options to be purchased and uses futures, interest options and swaptions to balance the position. Financial projections are produced using real world scenarios to ascertain the tail risk and establish sensitivities. The output from the hedge engine 180 is the specific buy and sell positions 220 that provide the appropriate balance.

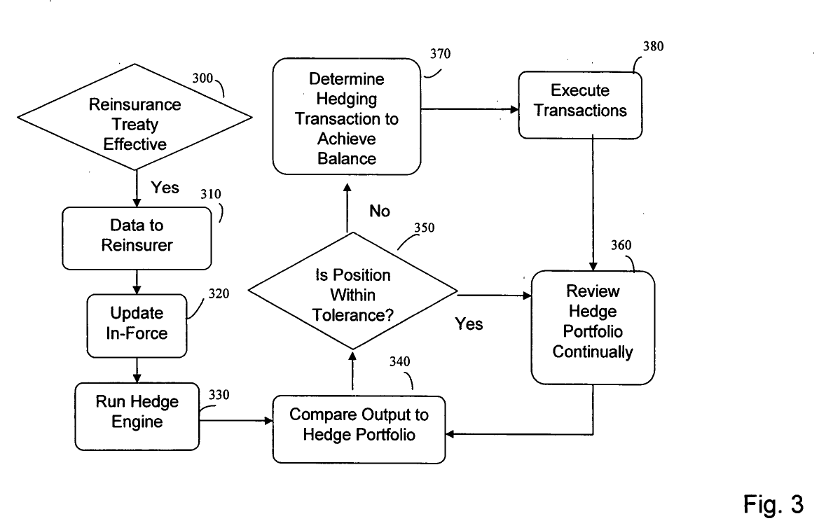

The systems and methods described herein can also function to periodically review and update the appropriate hedge positions as economic conditions and the aggregate characteristics of the reinsured contracts change. Referring to FIG. 3, the system determines if a reinsurance agreement is in place with one or more contract issuers (step 300). If such an agreement is in place, the data describing the various characteristics of the contracts is sent to the reinsurer (step 310). The in-force contract data is updated (step 320) and supplied to the hedge engine. The hedge engine, using the various inputs described above, calculates (step 330) one or more portfolios that include various hedge positions for hedging the risks inherent in the current set of in-force contracts. One or more of the resulting portfolios is then selected as the desired portfolio. The result is compared (step 340) to the existing portfolio. In some embodiments, one or more tolerance bands may be established to determine if adjustments to the portfolio are necessary and used when comparing the existing portfolio to the new portfolio (step 350). For example, if a very small deviation from the newly selected portfolio exists, the transaction costs associated with the buying and/or selling of options may outweigh any benefits. Therefore, if the new portfolio is within the tolerance bands, the review process repeats on a periodic (hourly, daily, weekly, etc.) basis (step 360). However, if the selected portfolio is outside the established tolerances, the hedge transactions that will create the selected portfolio are determined (step 370), and forwarded to a trader for execution (step 380).

For example, if a portfolio were constructed to hedge GMDBs on an underlying asset pool, and due to lapsation of variable annuity policies, the pool became smaller over time, the optimal hedging portfolio at one point in time will have to shrink in proportion to the lapsation of the policies. As an alternative example, if market parameters change significantly, it is likely that the optimization process in [00035] will lead to a new optimal portfolio that is significantly different than the one computed prior to the change in market parameters.

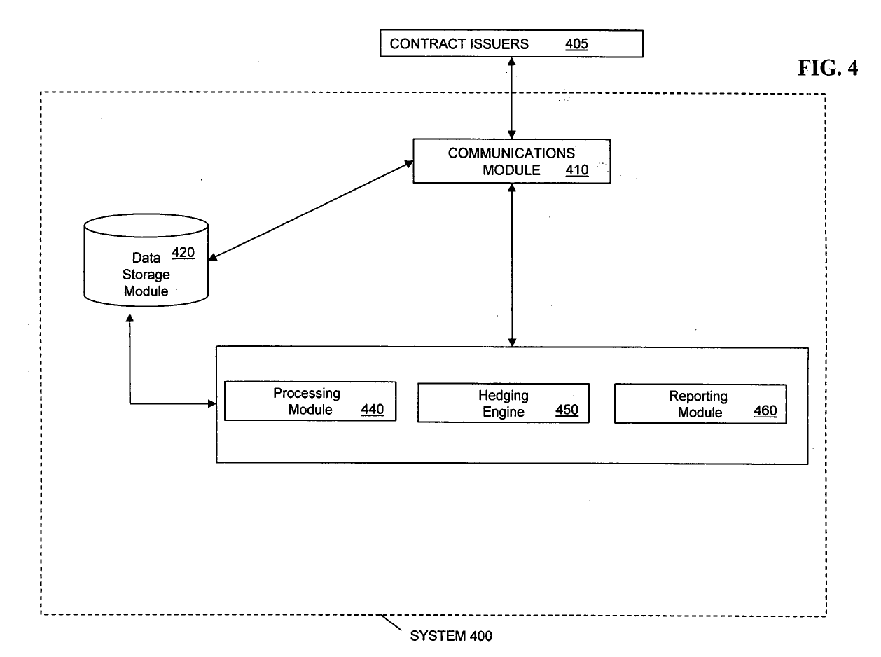

FIG. 4 depicts one embodiment of a system 400 on which the methods described above may be implemented. Contract issuers 405 such as insurance companies provide data regarding the characteristics of variable annuity contracts to a communications module 410 system via a communications link (e.g., the Internet) using one or more data exchange protocols such as EDI, XML, SOAP/Web Services, etc. The data is stored in a data storage module 420, such as one or more databases, flat files, or storage mediums. A processing module 440 calculates the various statistics and, based on the statistics a hedging engine 450, identifies the various hedge positions that afford appropriate risk mitigation positions. A reporting module 460 provides periodic and/or ad hoc reports relating to the details of individual contracts, aggregate information about the collection of contracts being hedged, the statistics described above (either at a point in time or on a periodic basis), and the current set of options positions.

In some embodiments, the communications module 410 collects general economic data (e.g., stock market indices, specific equity and debt pricings, etc.) from one or more data subscription services such as Dow Jones, Reuters, and others. In some embodiments the communications module 410 transmits instructions for executing the trades determined by the hedging engine to brokerage firms for execution, clearance, and custodial services provided by such firms.

In some embodiments, communications module 410, data storage module 420, processing module 440, hedging engine 450 and reporting module 460 may implement the functionality of the present invention in hardware or software, or a combination of both on a general-purpose computer. In addition, such a program may set aside portions of a computer's random access memory to provide control logic that affects one or more of the image manipulation, mapping, alignment, and support device control. In such an embodiment, the program may be written in any one of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80x86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

Although a preferred embodiment is specifically illustrated and described herein, it will be appreciated that modifications and variations of the present invention are covered by the above teachings and within the purview of the appended claims without departing from the spirit and intended scope of this invention.

What is claimed is:

1. A method for mitigating risks associated with a reinsured annuity contract, the method comprising:
determining statistical measures of risks associated with the reinsured annuity contract; and
mitigating the measured risk through active hedging.

2. The method of claim 1 wherein the reinsured annuity contract provides a guaranteed minimum death benefit.

3. The method of claim 1 wherein the reinsured annuity contract provides a guaranteed minimum income benefit.

4. The method of claim 1 wherein the reinsured annuity contract provides a guaranteed minimum accumulation benefit.

5. The method of claim 1 wherein the reinsured annuity contract provides a guaranteed minimum withdrawal benefit.

6. The method of claim 1 further comprising purchasing the annuity contract from a guarantor of the risk.

7. The method of claim 1 wherein the reinsured annuity contract comprises an income stream risk and a payout risk.

8. The method of claim 7 wherein the income stream risk and payout risk are measured independently.

9. The method of claim 1 wherein measuring the risk comprises calculating an account value for the reinsured annuity contract.

10. The method of claim 9 wherein the account value is based, at least in part on account features of the reinsured annuity contract and demographics of a policyholder of the reinsured annuity contract.

11. The method of claim 9 wherein the account features comprise one or more of a product type, a death benefit, a withdrawal amount, a lapse period, a ratchet value, a fund selection, and a rollup value.

12. The method of claim 10 wherein demographics of a policyholder of the variable annuity contract comprise an age, a gender, and a mortality rate.

13. The method of claim 1 further comprising calculating the delta, gamma, vega, theta and rho for the annuity contract.

14. The method of claim 13 wherein the active hedging comprises matching at least one of the delta, gamma, vega, theta and rho to a portfolio of options contracts.

15. A method for hedging risks associated with reinsuring variable annuity contracts with guaranteed minimum death benefits, the method comprising:
reinsuring a plurality of variable annuity contracts with guaranteed minimum death benefits;
calculating a plurality of risk statistics based on characteristics of the plurality of guaranteed minimum death benefit variable annuity contracts;
determining market indices to model the performance of the reinsured variable annuity contracts based on the plurality of risk statistics; and
hedging the risks associated with the reinsured variable annuity contracts by purchasing option contracts based, at least in part, on the determined market indices.

16. The method of claim 15 wherein the reinsured variable annuity contracts with guaranteed minimum death benefits comprise an income stream and an on-death payout amount.

17. The method of claim 16 wherein the calculated risk statistics comprise a first risk statistic based, at least in part, on the income stream and a second risk statistic based, at least in part, on the on-death payout amount.

18. The method of claim 15 wherein the market index is selected from the group comprising of the Standard & Poor's 500 index, the Russell 3000 index, the Wilshire 5000 index, the NASDAQ 100 index, the Dow Jones index, the Europe, Australia and Far East (EAFE) index, and combinations thereof.

19. The method of claim 15 wherein the option contracts comprises a put option.

20. A system for identifying hedge positions to mitigate risks associated with reinsuring guaranteed minimum death benefit variable annuity contracts, the system comprising:
a data storage module for storing information associated with guaranteed variable annuity contracts, the guaranteed variable annuity contracts having been purchased from a primary insurer;
a processing module in electronic communication with the data storage module for calculating one or more risk statistics based on the information associated with the guaranteed variable annuity contracts; and
a hedging engine in electronic communication with the processing module and data storage module for identifying a hedge position to mitigate risks associated with the guaranteed variable annuity contracts based at least in part on the calculated risk statistics.

21. The system of claim 20 further comprising a trading system for executing trades associated with the identified hedge positions.

22. The system of claim 20 wherein the risk statistics are calculated periodically.

23. The system of claim 20 further comprising a reporting module for producing reports comprising information associated with the guaranteed variable annuity contracts, the risk statistics, and the hedge position.

24. The system of claim 23 wherein the reports are formatted for printing.

25. The system of claim 20 further comprising a communications module in electronic communication with the data storage module for receiving the information associated with variable annuity contracts.
